(19) United States
(12) Patent Application Publication
(10) Pub. No.: US 2016/0054792 A1
(43) Pub. Date: Feb. 25, 2016

(54) Radar-Based Biometric Recognition

(71) Applicant: Google Inc., Mountain View, CA (US)

(72) Inventor: Ivan Poupyrev, Sunnyvale, CA (US)

(21) Appl. No.: 14/518,863

(22) Filed: Oct. 20, 2014

Related U.S. Application Data
(60) Provisional application No. 62/040,834, filed on Aug. 22, 2014.

(51) Int. Cl. G06F 3/01

(52) U.S. Cl. CPC G06F 3/011; G06F 3/014

(57) ABSTRACT

This document describes techniques and devices for radar-based biometric recognition. The techniques enable biometric recognition through a radar-based biometric-recognition system thereby permitting control of devices and applications with little or no active engagement from users.

### PRIORITY APPLICATION

This application claims priority under 35 U.S.C. §119(e) to U.S. Provisional Patent Application No. 62/040,834, entitled “Radar-Based Biometric Recognition” and filed on Aug. 22, 2014, the disclosure of which is incorporated in its entirety by reference herein.

### BACKGROUND

With the proliferation of computing devices in nearly every aspect of modern life—from automobiles to home appliances—devices to control these computing devices have also proliferated, such as a television's remote, a gaming system's gesture-sensing camera, a tablet computer's touch screen, a desktop computer's keyboard, a smart-phone's audio-based controller, or a microwave oven's button control pad. These conventional control devices fail to provide easy and intuitive control desired by users, instead requiring users to learn and manage various different control devices.

Furthermore, even in the best of cases, these various control devices require users to actively engage with the control device, whether it be pressing a button on a button control pad, waving an arm in front of a gesture-sensing camera, or tapping a control on a touchscreen.

### SUMMARY

This document describes techniques and devices for radar-based biometric recognition. The techniques enable biometric recognition through a radar-based biometric-recognition system thereby permitting control of devices and applications with little or no active engagement from users. This summary is provided to introduce simplified concepts concerning radar-based biometric recognition, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices for radar-based biometric recognition are described with reference to the following drawings. The same numbers are used throughout the drawings to reference like features and components:

FIG. 1 illustrates an example environment in which radar-based biometric recognition can be implemented, including a biometric-recognition device and a remote device in communication through a network.

FIG. 2 illustrates an example radar-based biometric-recognition system and the biometric-recognition device of FIG. 1.

FIG. 3 illustrates an example 3D volume radar field emitted by the radar-based biometric-recognition system of FIG. 2.

FIG. 4 illustrates an example surface radar field emitted by the radar-based biometric-recognition system of FIG. 2.

FIG. 5 illustrates the remote device of FIG. 1 in greater detail.

FIG. 6 illustrates an example method for radar-based biometric recognition.

FIG. 7 illustrates a method enabling use of a radar-based biometric recognition, including to control a device or an application.

FIG. 8 illustrates a person sitting on a couch and passively interacting with a radar field provided by a peripheral radar-based biometric-recognition system.

FIG. 9 illustrates an example device embodying, or in which techniques may be implemented that enable use of, a radar-based biometric recognition.

### DETAILED DESCRIPTION

### Overview

This document describes techniques using, and devices enabling, radar-based biometric recognition. Through use of a radar-based biometric-recognition system, the techniques can determine, even without a user's active engagement, a biometric condition for that user. Based on this biometric condition, the techniques can control various devices and applications. Consider, for example, a case where a person has a potential health problem, such as a heart arrhythmia or a temperature over 103° F. These techniques can recognize this biometric condition and then contact an emergency response application to request medical assistance. These techniques are also capable of other radar-based biometric recognitions and related control, such as to control an exercise program based on a user's heartbeat, a thermostat based on a user's skin temperature, or media playing device based on a user's stress level, to name just a few.

These are but a few examples of how techniques and/or devices enabling use of radar-based biometric recognition can be performed. This document now turns to an example environment, after which example radar-based biometric-recognition systems, example methods, and an example computing system are described.

### Example Environment

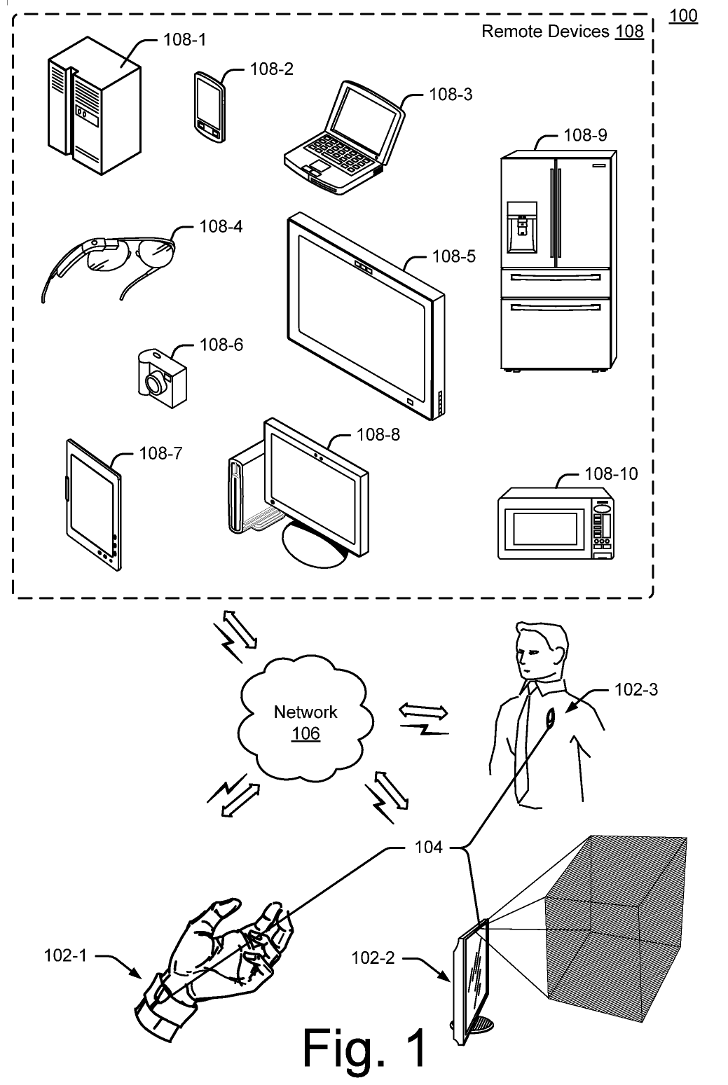

FIG. 1 is an illustration of an example environment 100 in which techniques using, and an apparatus including, a radar-based biometric-recognition system may be embodied. Environment 100 includes examples of a biometric-recognition device 102, radar-based biometric-recognition systems 104, a network 106, and remote devices 108. Environment 100 includes three example biometric-recognition devices 102, each of which includes radar-based biometric-recognition system 104, the first is shown at bracelet computing device 102-1, the second is shown at integrated biometric-recognition device 102-2, and the third is shown at wearable brooch 102-3. These example devices demonstrate a few of the many ways in which radar-based biometric-recognition systems can be embodied, others of which are described below.

Each of biometric-recognition devices 102 may interact with remote devices 108 through network 106 and by transmitting input responsive to recognizing biometric conditions, such as body temperature, skeletal orientation or movement, and heart rate. Biometric conditions can be mapped to various devices and applications, whether at the biometric-recognition device having the radar-based biometric-recognition system or at one of remote devices 108, thereby enabling control of many devices and applications. Radar-based biometric-recognition systems 104, whether integrated with a computing device having substantial computing capabilities or as a device having few computing abilities, can be used to interact with remote devices 108. Biometric conditions also include blood pressure, skin temperature, breathing rate, and oxygen or carbon dioxide content of breath, to name just a few. These and other conditions can be determined based on measuring a user's heart movement, quantity of blood in capillaries or veins (e.g., the capillaries or full or not full), skin perspiration, bones or cartilage orientations, movement of ribs (breathing rate), chemical content or temperature of air expelled from user, temperature of skin or interior (muscle or blood), and so forth.

Network 106 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Remote devices 108 are illustrated with various non-limiting example devices: server 108-1, smartphone 108-2, laptop 108-3, computing spectacles 108-4, television 108-5, camera 108-6, tablet 108-7, desktop 108-8, refrigerator 108-9, and microwave 108-10, though other devices may also be used, such as home automation and control systems, sound or entertainment systems, security systems, netbooks, and e-readers. Note that remote device 108 can be wearable, non-wearable but mobile, or relatively immobile (e.g., desktops, servers, and appliances).

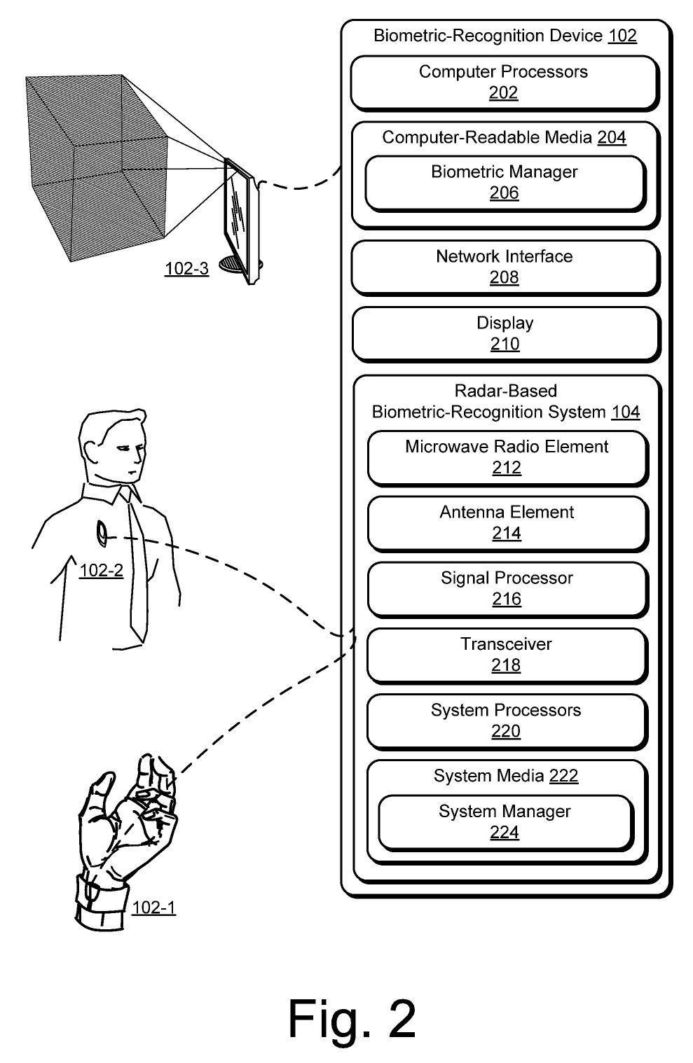

In more detail, consider FIG. 2, which illustrates radar-based biometric-recognition system 104 both as part, and independent, of biometric-recognition device 102. Note also that radar-based biometric-recognition system 104 can be used with, or embedded within, many different garments, accessories, and computing devices, such as the example remote devices 108 noted above, jackets (e.g., with a radar field generated from a device integral with a shirt pocket), hats, books, computing rings, spectacles, and so forth. Further, the radar field can be invisible and penetrate some materials, such as textiles, thereby further expanding how the radar-based biometric-recognition system 104 can be used and embodied.

While examples shown herein generally show one radar-based biometric-recognition system 104 per device, multiples can be used, thereby increasing a number and complexity of biometric recognition, as well as accuracy and robust recognition. Biometric-recognition device 102 includes one or more computer processors 202 and computer-readable media 204, which includes memory media and storage media. Applications and/or an operating system (not shown) embodied as computer-readable instructions on computer-readable media 204 can be executed by processors 202 to provide some of the functionalities described herein. Computer-readable media 204 also includes biometric manager 206 (described below).

Biometric-recognition device 102 may also include network interfaces 208 for communicating data over wired, wireless, or optical networks. By way of example and not limitation, network interface 208 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like (e.g., through network 106 of FIG. 1). Biometric-recognition device 102 may include a display 210, which can be touch-sensitive, though this is not required.

Radar-based biometric-recognition system 104, as noted above, is configured to sense biometric conditions. To enable this, radar-based biometric-recognition system 104 includes a microwave radio element 212, an antenna element 214, and a signal processor 216.

Generally, microwave radio element 212 is configured to provide a radar field. This radar field can be small or large—such as less than one half of one meter from the microwave radio element to large enough to fill a large room. Microwave radio element 212 can be configured to provide a radar field configured to reflect from human tissue and penetrate non-human material. Microwave radio element 212 may emit continuously modulated radiation, ultra-wideband radiation, or sub-millimeter-frequency radiation. Microwave radio element 212, in some cases, is configured to form radiation in beams, the beams aiding antenna element 214 and signal processor 216 to determine which of the beams are interrupted, and thus locations of human tissue within the radar field.

Antenna element 214 is configured to receive reflections from human tissue in the radar field, and signal processor 216 is configured to process the reflections from the human tissue in the radar field sufficient to provide biometric data usable to determine a biometric condition. Antenna element 214 can include one or many sensors, such as an array of radiation sensors, the number in the array based on a desired resolution and whether the field is a surface or volume.

The field provided by microwave radio element 212 can be a three-dimensional (3D) volume (e.g., hemisphere, volumetric fan, cube, or cylinder) or a surface applied to human tissue. In the case of a 3D volume, antenna element 214 is configured to receive reflections from human tissue in the 3D volume, such as skin, bone, or heart muscle. Signal processor 216 is configured to process the reflections in the 3D volume sufficient to provide biometric data usable to determine biometric conditions in three dimensions, such as a temperature of a person's arm at multiple points in and around the arm.

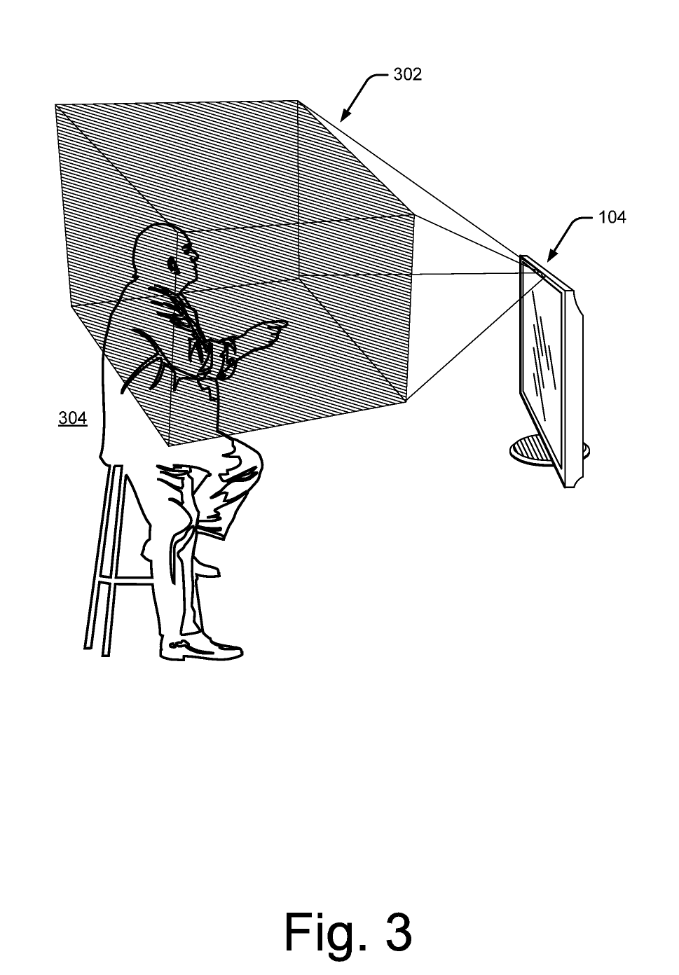

An example of a 3D volume is illustrated in FIG. 3, which shows 3D volume radar field 302 emitted by radar-based biometric-recognition system 104 integrated within biometric-recognition device 102-2. Through 3D volume radar field 302, the techniques may determine a biometric condition for person 304, and based on this determined biometric condition control a device or application. Thus, if person 304 is determined to be too hot based on his body temperature, the techniques may communicate with a thermostat to decrease the room's temperature or turn on a ceiling fan.

The radar field can also include a surface applied to human tissue. In this case, antenna element 214 is configured to sense a human-tissue reflection on the surface and signal processor 216 is configured to process the sensed human-tissue reflection on the surface sufficient to provide biometric data usable to determine a biometric condition.

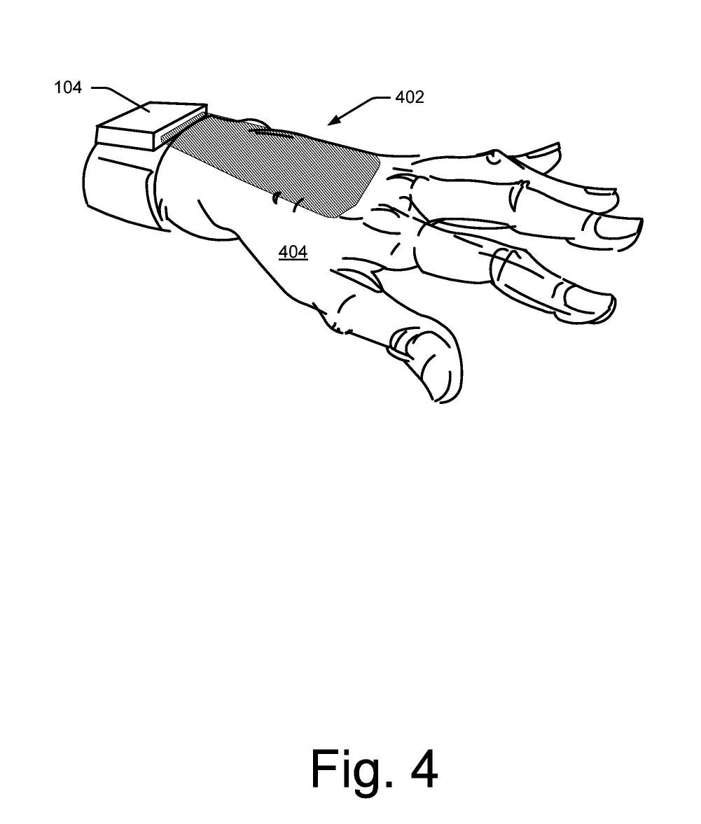

An example surface is illustrated in FIG. 4, at surface radar field 402, emitted by radar-based biometric-recognition system 104 of FIG. 1. Through surface radar field 402, the techniques may determine a skin temperature, heart rate, or amount perspiration on a user's left hand 404 (via water or salt on the skin). Based on one or more of these biometric conditions, the techniques can control various devices or applications.

Returning to FIG. 2, radar-based biometric-recognition system 104 also includes a transceiver 218, which is configured to transmit biometric data to a remote device, though this many not be used when radar-based biometric-recognition system 104 is integrated with biometric-recognition device 102. Biometric data can be provided in a format usable by remote device 108 sufficient for remote device 108 to determine the biometric condition in those cases where the biometric condition is not determined by radar-based biometric-recognition system 104 or biometric-recognition device 102.

In more detail, microwave radio element 212 can be configured to emit microwave radiation at a 57 GHz to 63 GHz range or as broadly as a 1 GHz to 300 GHz range, to provide the radar field. This range affects antenna element 214's ability to receive reflections from human tissue at a particular resolution, e.g., about two to about 25 millimeters. Microwave radio element 212 can be configured, along with other entities of radar-based biometric-recognition system 104, to have a relatively fast update rate, which can aid in resolution of the human-tissue reflections.

By selecting particular frequencies, radar-based biometric-recognition system 104 can operate to substantially penetrate clothing while not substantially penetrating human tissue. Further, antenna element 214 or signal processor 216 can be configured to differentiate between human-tissue reflections in the radar field caused by clothing from those human-tissue reflections in the radar field caused by human tissue. Thus, a wearer of radar-based biometric-recognition system 104 may have a jacket or shirt covering microwave radio element 212 (or even embodying microwave radio element 212) and a glove covering one or more hands, but radar-based biometric-recognition system 104 remains functional. In addition to this, antenna element 214 and signal processor 216 can be configured to differentiate between different types of human tissue. These different types include skin, muscle, particular types of muscle (heart and skeletal), bone, blood, and cartilage.

Radar-based biometric-recognition system 104 may also include one or more system processors 220 and system media 222 (e.g., one or more computer-readable storage media). System media 222 includes system manager 224, which, alone or in conjunction with biometric manager 206 or remote biometric manager 508, can perform various operations, including determining a biometric condition based on biometric data from signal processor 216, mapping the determined biometric condition to a particular device or application or control input, and/or pre-configured control associated with a biometric condition to control input for an application associated with remote device 108. System manager 224 is also configured to cause transceiver 218 to transmit the control input to the remote device effective to enable control of the device or application. This is but one of the many ways in which the above-mentioned control through radar-based biometric-recognition system 104 can be enabled, which as noted, can be without the user's active engagement, and therefore can be fully passive in some cases. Operations of system manager 224, biometric manager 206, and remote biometric manager 508 are provided in greater detail as part of methods 600 and 700 below.

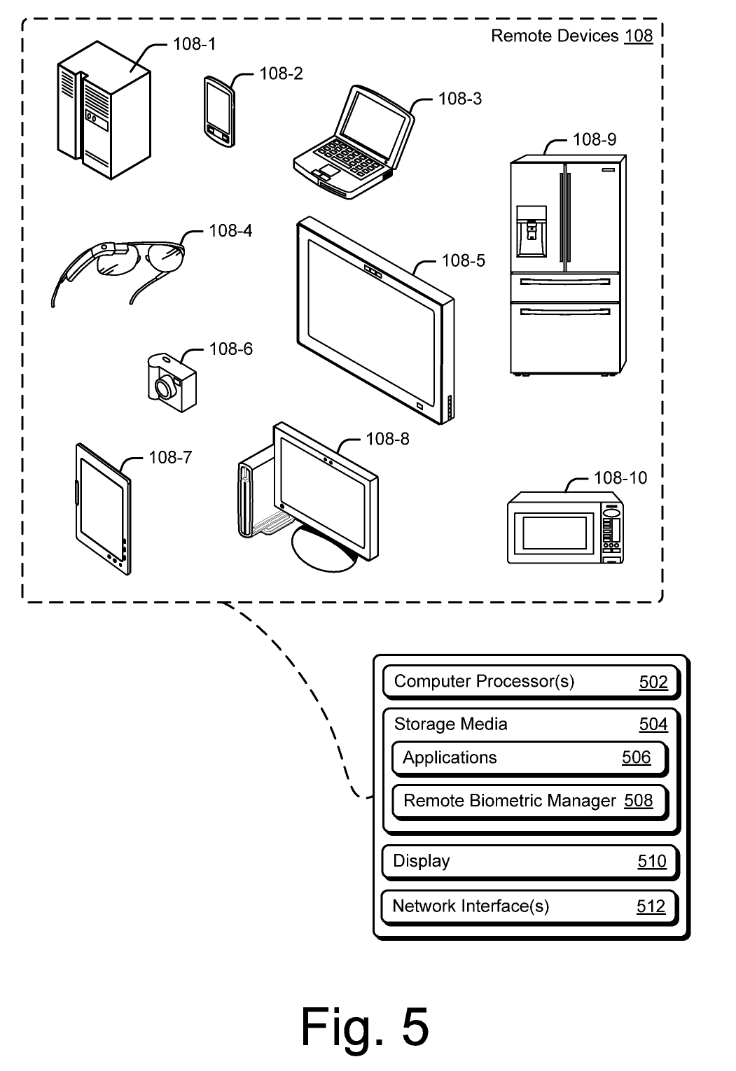

Returning to FIG. 1, consider remote device 108, which includes example devices that can be controlled based on recognized biometric conditions, as well as their associated applications. In more detail, consider remote device 108 as illustrated in FIG. 5. Remote device 108 includes one or more computer processors 502 and computer-readable storage media (storage media) 504. Storage media 504 includes applications 506, remote biometric manager 508, and/or an operating system (not shown) embodied as computer-readable instructions executable by computer processors 502 to provide, in some cases, functionalities described herein.

Remote device 108 may also include a display 510 and network interfaces 512 for communicating data over wired, wireless, or optical networks. By way of example and not limitation, network interface 512 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

Remote biometric manager 508 is capable of interacting with applications 506 and radar-based biometric-recognition system 104 effective to aid, in some cases, control of applications 506 through biometric recognition (or data related thereto) made by radar-based biometric-recognition system 104. As noted above, remote devices 108 are not required to include remote biometric manager 508, such as in cases where a control input or other type of control is received from biometric-recognition device 102.

These and other capabilities and configurations, as well as ways in which entities of FIGS. 1-5 act and interact, are set forth in greater detail below. These entities may be further divided, combined, and so on. The environment 100 of FIG. 1 and the detailed illustrations of FIGS. 2-5 illustrate some of many possible environments and devices capable of employing the described techniques.

### Example Methods

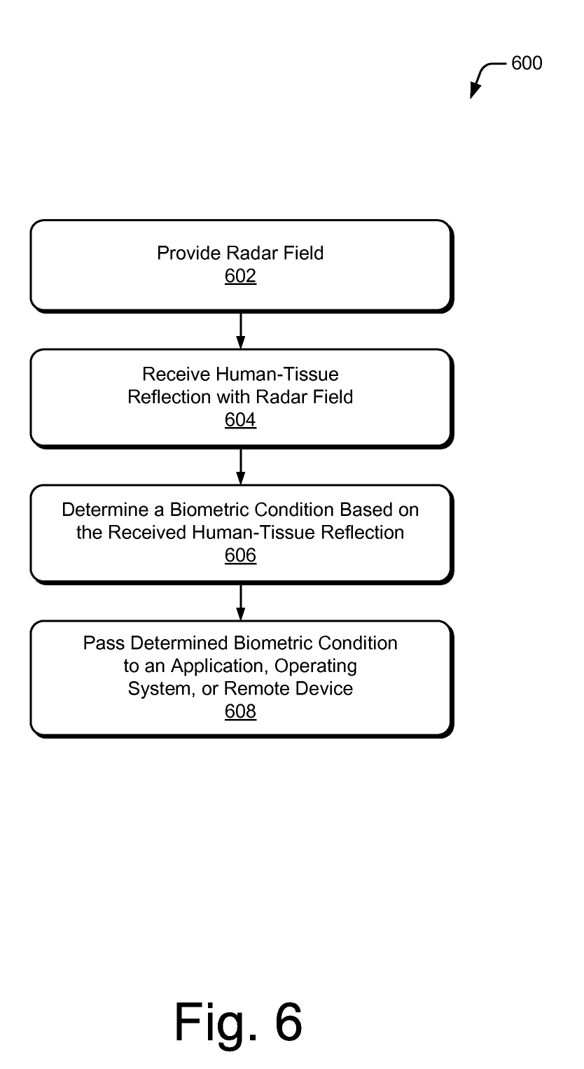

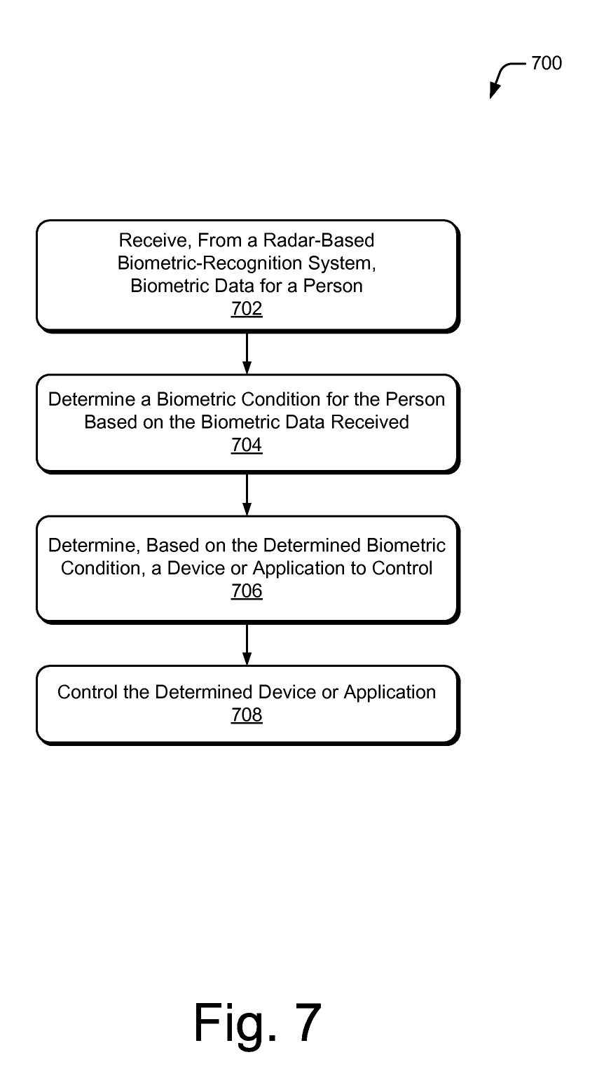

FIGS. 6 and 7 depict methods enabling or using radar-based biometric recognition. These methods are shown as sets of blocks that specify operations performed but are not necessarily limited to the order or combinations shown for performing the operations by the respective blocks. In portions of the following discussion reference may be made to environment 100 of FIG. 1 and entities detailed in FIGS. 2-5, reference to which is made for example only. The techniques are not limited to performance by one entity or multiple entities operating on one device.

At 602, a radar field is provided. This radar field can be caused by one or more of biometric manager 206, system manager 224, signal processor 216, or remote biometric manager 508. Thus, system manager 224 may cause microwave radio element 212 of radar-based biometric-recognition system 104 to provide (e.g., project or emit) one of the described radar fields noted above.

At 604, a human-tissue reflection in the radar field is received. Human-tissue reflections include the many noted above, such as reflections from muscle, skin, and bone, to name a few.

At 606, a biometric condition is determined based on the sensed human-tissue reflection in the radar field. The sensed human-tissue reflection can be processed by signal processor 216, which may provide biometric data for later determination of the biometric condition, such as by system manager 224, biometric manager 206, or remote biometric manager 508, as noted herein.

At 608, the determined biometric condition is passed to an application, operating system, or device effective to enable the application, operating system, or device to receive an input corresponding to the determined biometric condition. As noted, this determination can be performed by various entities, such as biometric manager 206. To perform this determination, the techniques may map determined biometric conditions to one of multiple control inputs associated with the devices and applications. Thus, a biometric condition of heart arrhythmia can be mapped to an emergency response application, a biometric condition of a person that is asleep can map to multiple devices capable of providing audio sufficient to reduce the volume of the audio when a person falls asleep.

To illustrate method 600, consider four examples; in the first, the biometric condition indicates a possible health problem for the person. In such a case, at 608, biometric manager 206 determines that an emergency-response application should receive input indicating the possible health problem, and then the biometric condition is passed to the emergency-response application effective to cause the emergency response application to request medical assistance for the person.

By way of the second example, assume that the biometric condition indicates a body temperature or heart rate for the person. Based on this determination, biometric manager 206 determines that control of an exercise program is appropriate. This determination can be based on the exercise program being currently interacted with or presented, or based on the biometric condition itself. Biometric manager 206 controls the exercise program effective to cause the exercise program to record the body temperature or heart rate for the person or to control the exercise regimen of exercise program. Thus, if the person's heart rate is too high, the exercise program may slow down or otherwise alter exercise regimen and vice versa if the person's heart rate is too slow. Similarly, if the person's body temperature is too high, biometric manager 206 may cause the exercise program to pause or slow down as well.

By way of a third example, assume that the biometric condition indicates a body temperature for the person and that biometric manager 206 determines that a climate device should be controlled. Based on this body temperature being too hot, or to cold, biometric manager 206 controls the claimant device to raise or lower the temperature or slow or speed air movement based on the body temperature. Thus, in a house or apartment having a ceiling fan, biometric manager may determine to turn up the speed of the fan or to turn down the speed of the fan.

By way of a fourth example, assume that the biometric condition indicates the stress, energy, or level of awakeness for the person. Based on this biometric condition, biometric manager 206 may determine various different applications and devices to control, such as a media-playing device or application. Thus, if the biometric condition indicates that the person is stressed, biometric manager 206 may determine to reduce ambient lighting in the room in which the person resides, change music being played to calming music, and the like. Similarly, if the biometric condition indicates that the person has a low energy level, biometric manager 206 may decrease the temperature in the room, change a style of music being played, or alter a volume of media being presented. Further still, if the biometric condition indicates the person is asleep or falling asleep, biometric manager 206 may cause a media player to pause or reduce a volume of the media being played.

While each of these examples enables easy and intuitive control of devices and applications without a user having to engage with the device or application, active engagement is also enabled by the techniques. Thus, a biometric condition of a location, orientation, or movement of a bone or skeleton can be determined and used to control various devices and applications. A user may therefore perform an active movement to cause certain controls inputs to be passed effective to actively control those devices.

FIG. 7 depicts method 700, which enables control of a device or application through biometric data for a person sensed by a radar-based biometric-recognition system.

At 702, biometric data is received from a radar-based biometric-recognition system. Consider, for example, a case where radar-based biometric-recognition system 104 determines biometric data for a person interacting with a radar field. This biometric data can be received at a same device as the radar-based biometric-recognition system 104 or at a remote device or application. Thus, remote biometric manager 508 they receive biometric data from biometric-recognition device 102.

At 704, a biometric condition for the person is determined based on the biometric data received. Consider, by way of example, a case where a radar-based biometric-recognition system 104 is a peripheral to another device or operates within a biometric-recognition device 102 that has limited or no computer processors and computer-readable media. In such a case, biometric data may still be received from transceiver 218 after processing by signal processor 216 (and/or system manager 224 executed by system processors 220).

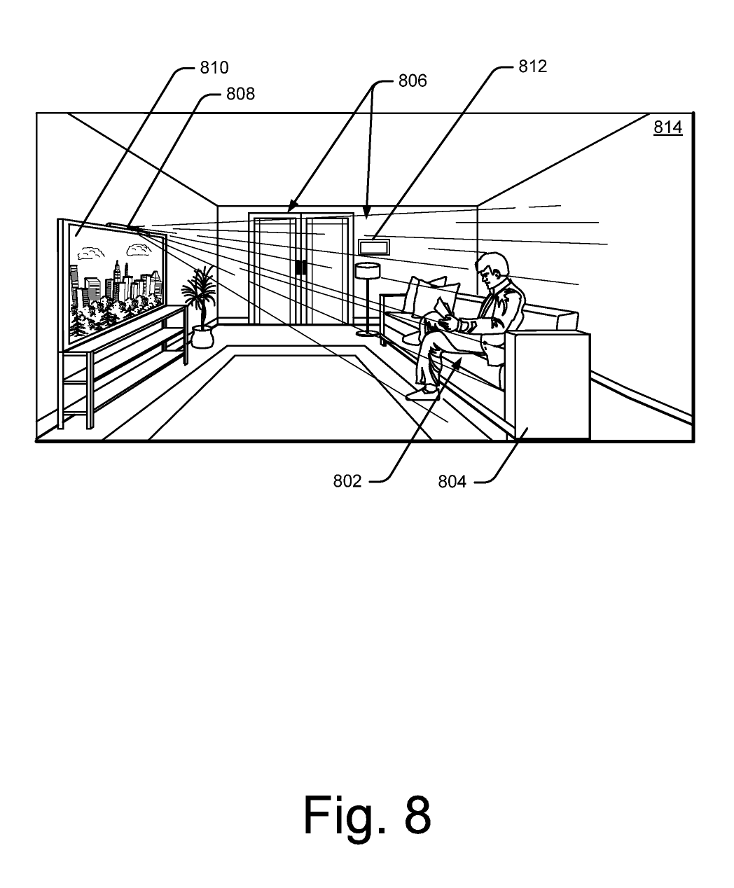

At 706, a device or application to control is determined based on the determined biometric condition. By way of illustration, consider FIG. 8, which shows a person 802 sitting on a couch 804 thereby passively interacting with radar field 806 provided by peripheral radar-based biometric-recognition system 808 (peripheral but in communication with media-presenting computing device 810). Here assume that peripheral radar-based biometric-recognition system 808 provides radar field 806 configured to reflect from human tissue and penetrate nonhuman material and senses human tissue reflections in radar field 806, which the system then processes sufficient to provide biometric data usable to determine a biometric condition from the sensed human-tissue reflections. This biometric data is received at 702 by media-presenting computing device 810, which includes remote biometric manager 508. Depending on the biometric condition determined at media-presenting computing device 810, remote biometric manager 508 may determine various different devices or applications to control, such as a volume or to pause a playback of media on media-presenting computing device 810 if the person falls asleep. In this particular example, assume that the biometric condition is a skin temperature of person 802, which is higher than generally desired. In such case, remote biometric manager 508 determines that the device to control is a thermostat 812 for a room 814 in which person 802 resides.

At 708, the device or application is controlled. As noted above, this control can be exercised on the same device as the radar-based biometric-recognition system, a device that receives the biometric data at 702, or another device or application. Concluding the ongoing example, remote biometric manager 508 controls the thermostat to lower the temperature in the room in which person 802 resides.

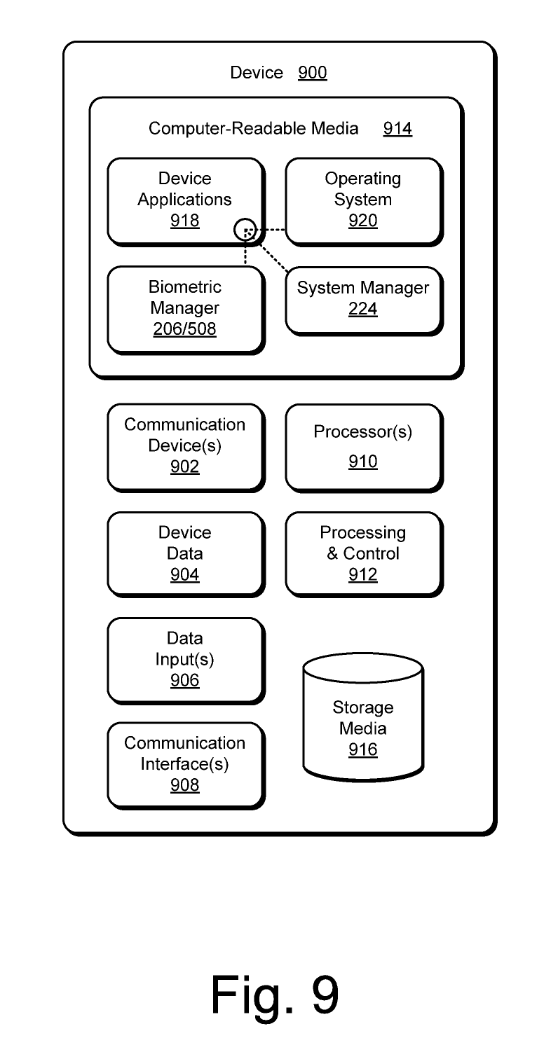

The preceding discussion describes methods relating to radar-based biometric recognition. Aspects of these methods may be implemented in hardware (e.g., fixed logic circuitry), firmware, software, manual processing, or any combination thereof These techniques may be embodied on one or more of the entities shown in FIGS. 1-8 and 9 (computing system 900 is described in FIG. 9 below), which may be further divided, combined, and so on. Thus, these figures illustrate some of the many possible systems or apparatuses capable of employing the described techniques. The entities of these FIGS. generally represent software, firmware, hardware, whole devices or networks, or a combination thereof.

### Example Computing System

FIG. 9 illustrates various components of example computing system 900 that can be implemented as any type of client, server, and/or computing device as described with reference to the previous FIGS. 1-8 to implement a radar-based biometric recognition. In embodiments, computing system 900 can be implemented as one or a combination of a wired and/or wireless wearable device, System-on-Chip (SoC), and/or as another type of device or portion thereof. Computing system 900 may also be associated with a user (e.g., a person) and/or an entity that operates the device such that a device describes logical devices that include users, software, firmware, and/or a combination of devices.

Computing system 900 includes communication devices 902 that enable wired and/or wireless communication of device data 904 (e.g., received data, data that is being received, data scheduled for broadcast, data packets of the data, etc.). Device data 904 or other device content can include configuration settings of the device, media content stored on the device, and/or information associated with a user of the device. Media content stored on computing system 900 can include any type of audio, video, and/or image data. Computing system 900 includes one or more data inputs 906 via which any type of data, media content, and/or inputs can be received, such as human utterances, human-tissue reflections with a radar field, user-selectable inputs (explicit or implicit), messages, music, television media content, recorded video content, and any other type of audio, video, and/or image data received from any content and/or data source.

Computing system 900 also includes communication interfaces 908, which can be implemented as any one or more of a serial and/or parallel interface, a wireless interface, any type of network interface, a modem, and as any other type of communication interface. Communication interfaces 908 provide a connection and/or communication links between computing system 900 and a communication network by which other electronic, computing, and communication devices communicate data with computing system 900.

Computing system 900 includes one or more processors 910 (e.g., any of microprocessors, controllers, and the like), which process various computer-executable instructions to control the operation of computing system 900 and to enable techniques for, or in which can be embodied, radar-based biometric recognition. Alternatively or in addition, computing system 900 can be implemented with any one or combination of hardware, firmware, or fixed logic circuitry that is implemented in connection with processing and control circuits which are generally identified at 912. Although not shown, computing system 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 900 also includes computer-readable media 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 900 can also include a mass storage media device 916.

Computer-readable media 914 provides data storage mechanisms to store device data 904, as well as various device applications 918 and any other types of information and/or data related to operational aspects of computing system 900. For example, an operating system 920 can be maintained as a computer application with computer-readable media 914 and executed on processors 910. Device applications 918 may include a device manager, such as any form of a control application, software application, signal-processing and control module, code that is native to a particular device, a hardware abstraction layer for a particular device, and so on.

Device applications 918 also include any system components, engines, or managers to implement radar-based biometric recognition. In this example, device applications 918 include biometric manager 206 or remote biometric manager 508 and system manager 224.

### Conclusion

Although embodiments of techniques using, and apparatuses including, radar-based biometric recognition have been described in language specific to features and/or methods, it is to be understood that the subject of the appended claims is not necessarily limited to the specific features or methods described. Rather, the specific features and methods are disclosed as example implementations of radar-based biometric recognition.

What is claimed is:

1. A computer-implemented method comprising:
receiving, from a radar-based biometric-recognition system configured to sense human tissue, biometric data for a person;
determining a biometric condition for the person based on the biometric data received from the radar-based biometric-recognition system;
determining, based on the determined biometric condition, a device or application to control; and
controlling the device or application.

2. The computer-implemented method as described in claim 1, wherein the biometric condition indicates a possible health problem for the person, determining the device or application to control determines an emergency response application, and controlling the device or application causes the emergency response application to request medical assistance for the person.

3. The computer-implemented method as described in claim 1, wherein the biometric condition indicates a body temperature or heart rate for the person, determining the device or application to control determines an exercise program, and controlling the device or application causes the exercise program to record the body temperature or the heart rate or alter an exercise regimen of the exercise program.

4. The computer-implemented method as described in claim 1, wherein the biometric condition indicates a body temperature for the person, determining the device or application to control determines a climate device, and controlling the device or application causes the climate device to raise or lower a temperature or air movement based on the body temperature.

5. The computer-implemented method as described in claim 1, wherein the biometric condition indicates a stress, energy, or awakeness level for the person, determining the device or application to control determines a media playing device or application, and controlling the device or application causes the media playing device or application to alter presentation of media based on the stress, energy, or awakeness level for the person.

6. The computer-implemented method as described in claim 1, wherein determining the device or application to control maps the determined biometric condition to one of multiple control inputs associated with respective devices and applications.

7. The computer-implemented method as described in claim 1, wherein controlling the device or application causes a transmitting device to transmit a control input to a remote device associated with the device or application effective to control of the device or application.

8. A radar-based biometric-recognition system comprising:
a microwave radio element configured to provide a radar field, the radar field configured to reflect from human tissue and penetrate non-human material;
an antenna element configured to sense human-tissue reflections in the radar field; and
a signal processor configured to process the sensed human-tissue reflections in the radar field sufficient to provide biometric data usable to determine a biometric condition from the sensed human-tissue reflections.

9. The radar-based biometric-recognition system as recited in claim 8, wherein the radar field is a small radar field, the radar-based biometric-recognition system is integral with a wearable computing device, and further comprising a transmitting device configured to transit the biometric data to a remote device, the biometric data provided in a format usable by the remote device to determine a biometric condition.

10. The radar-based biometric-recognition system as recited in claim 8, wherein the microwave radio element is further configured to provide the radar field configured to reflect from one type of human tissue differently from another type of human tissue.

11. The radar-based biometric-recognition system as recited in claim 8, wherein the human tissue is skin and the biometric condition is a temperature of the skin.

12. The radar-based biometric-recognition system as recited in claim 8, wherein the human tissue is skin and the biometric data indicates salt or water on the skin, the salt or water indicating that the biometric condition is perspiration.

13. The radar-based biometric-recognition system as recited in claim 8, wherein the human tissue is heart muscle and the biometric condition is a heart rate or condition of the heart muscle.

14. The radar-based biometric-recognition system as recited in claim 8, wherein the human tissue is bone and the biometric condition is skeletal orientation or movement.

15. The radar-based biometric-recognition system as recited in claim 8, wherein the microwave radio element provides the radar field as a surface penetrating fabric and applied to skin, the antenna element is capable of sensing a human-tissue reflection from the skin on the surface, and the signal processor is configured to process the sensed human-tissue reflection on the surface sufficient to provide biometric data usable to determine a temperature of, or a perspiration on, the skin.

16. The radar-based biometric-recognition system as recited in claim 8, wherein the antenna element or signal processor is configured to differentiate between reflections in the radar field caused by clothing from human-tissue reflections in the radar field caused by human tissue.

17. The radar-based biometric-recognition system as recited in claim 8, wherein the microwave radio element is configured to emit continuously modulated radiation, ultra-wideband radiation, or sub-millimeter-frequency radiation.

18. The radar-based biometric-recognition system as recited in claim 8, further comprising:
a transceiver;
one or more computer processors; and
one or more computer-readable storage media having instructions stored thereon that, responsive to execution by the one or more computer processors, perform operations comprising:
determining, based on the provided biometric data from the signal processor, the biometric condition;
mapping the determined biometric condition to a control input for an application associated with a remote device; and
causing the transceiver to transmit the control input to the remote device effective to enable control of the application.

19. A computing device comprising:
a radar-based biometric-recognition system;
one or more computer processors; and
one or more computer-readable storage media having instructions stored thereon that, responsive to execution by the one or more computer processors, perform operations comprising:
causing the radar-based biometric-recognition system to provide a radar field;
determining a biometric condition based on a human-tissue reflection in the radar field; and
passing the determined biometric condition to an application or operating system of the computing device or to a remote device effective to cause the application or operating system or the remote device to receive an input corresponding to the determined biometric condition.

20. The computing device of claim 19, wherein the radar-based biometric-recognition system includes a microwave radio element, an antenna element, and a signal processor, and wherein the operation of causing causes the microwave radio element to provide the radar field, the human-tissue reflection in the radar field is received by the antenna element and processed by the signal processor, and the determining is responsive to receiving the processed human-tissue reflection from the signal processor.
